(19) United States
(12) Patent Application Publication
(10) Pub. No.: US 2016/0187972 A1
(43) Pub. Date: Jun. 30, 2016

(54) APPARATUS, METHOD AND COMPUTER PROGRAM FOR USING GAZE TRACKING INFORMATION

(71) Applicant: Nokia Technologies Oy, Espoo (FI)

(72) Inventors: Debmalya BISWAS, Lausanne (CH); Julian NOLAN, Pully (CH); Matthew LAWRENSON, Bussignypres- de-lausanne (CH)

(21) Appl. No.: 14/931,408

(22) Filed: Nov. 3, 2015

(30) Foreign Application Priority Data
Nov. 13, 2014 (GB) 1420154.5

(51) Int. Cl. G06F 3/01

(52) U.S. Cl. CPC G06F 3/013

(57) ABSTRACT

An apparatus, method and computer program, the apparatus comprising: processing circuitry; and memory circuitry including computer program code; the memory circuitry and the computer program code configured to, with the processing circuitry, cause the apparatus at least to perform: obtaining gaze tracking information from a plurality of users wherein the gaze tracking information indicates whether or not a user looked at an object; and analysing the obtained gaze tracking information to categorize objects as different types of objects.

### TECHNOLOGICAL FIELD

An apparatus, method and computer program for using gaze tracking information. An apparatus, method and computer program for using gaze tracking information where the gaze tracking information is obtained from a plurality of users.

### BACKGROUND

Gaze tracking devices which can be used to monitor the gaze of a user are known. Such devices may be arranged to monitor the gaze of the user while the user is travelling, for example if a user is driving or walking.

It is useful to use the obtained gaze tracking information to provide improved services to the users.

### BRIEF SUMMARY

According to various, but not necessarily all, examples of the disclosure there may be provided an apparatus comprising: processing circuitry; and memory circuitry including computer program code; the memory circuitry and the computer program code configured to, with the processing circuitry, cause the apparatus at least to perform: obtaining gaze tracking information from a plurality of users wherein the gaze tracking information indicates whether or not a user looked at an object; and analysing the obtained gaze tracking information to categorize objects as different types of objects.

In some examples the information that is used to categorise objects may comprise the percentage of users in a given location with gaze tracking information indicating that they were looking at a given object.

In some examples the different types of objects may comprise objects providing information for road users and points of interest.

In some examples the apparatus may be further configured to compare gaze tracking information from different users to identify groups of users with similar interests. Groups of users with similar interests may be identified by analysing the obtained gaze tracking information to identify users who look at similar types of objects at different locations.

In some examples the apparatus may be further configured to analyse the obtained gaze tracking information to determine changes in objects. Changes in objects may be determined by comparing gaze tracking information obtained at a first time with gaze tracking information obtained at a second time. Changes in objects may be determined by comparing gaze tracking information from a plurality of users having similar interests.

In some examples the apparatus may be further configured to use information indicative of a change in an object to provide information to other users.

In some examples the apparatus may be further configured to identify information relating to users who share gaze tracking information. The information relating to users who share gaze tracking information may comprise at least one of: the percentage of users sharing gaze tracking information, the percentage of users sharing gaze tracking information relating to a given type of object, the percentage of users sharing gaze tracking information at a location.

In some examples the apparatus may be further configured to provide information relating to users who share gaze tracking information to the user devices.

In some examples the gaze tracking information may comprise at least one of identification of a user, identification of time when the gaze tracking information was collected, the location at which the gaze tracking information was collected, the direction of the user's gaze, information relating to an object that the user was looking at.

In some examples there may be provided a server comprising an apparatus as described above.

According to various, but not necessarily all, examples of the disclosure there may be provided a method comprising: obtaining gaze tracking information from a plurality of users wherein the gaze tracking information indicates whether or not a user looked at an object; and analysing the obtained gaze tracking information to categorize objects as different types of objects.

In some examples the information that is used to categorise objects may comprise the percentage of users in a given location with gaze tracking information indicating that they were looking at a given object.

In some examples the different types of objects may comprise objects providing information for road users and points of interest.

In some examples the method may further comprise comparing gaze tracking information from different users to identify groups of users with similar interests. Groups of users with similar interests are identified by analysing the obtained gaze tracking information to identify users who look at similar types of objects at different locations.

In some examples the method may further comprise analysing the obtained gaze tracking information to determine changes in objects. Changes in objects may be determined by comparing gaze tracking information obtained at a first time with gaze tracking information obtained at a second time. In some examples changes in objects may be determined by comparing gaze tracking information from a plurality of users having similar interests.

In some examples the method may further comprise using information indicative of a change in an object to provide information to other users.

In some examples the method may further comprise identifying information relating to users who share gaze tracking information. The information relating to users who share gaze tracking information may comprise at least one of: the percentage of users sharing gaze tracking information, the percentage of users sharing gaze tracking information relating to a given type of object, the percentage of users sharing gaze tracking information at a location.

In some examples the method may further comprise providing information relating to users who share gaze tracking information to the user devices.

In some examples the gaze tracking information may comprise at least one of identification of a user, identification of time when the gaze tracking information was collected, the location at which the gaze tracking information was collected, the direction of the user's gaze, information relating to an object that the user was looking at.

According to various, but not necessarily all, examples of the disclosure there may be provided a computer program comprising computer program instructions that, when executed by at least one processor, enable an apparatus at least to perform: obtaining gaze tracking information from a plurality of users wherein the gaze tracking information indicates whether or not a user looked at an object; and analysing the obtained gaze tracking information to categorize objects as different types of objects.

According to various, but not necessarily all, examples of the disclosure there may be provided a computer program comprising program instructions for causing a computer to perform the method described above.

According to various, but not necessarily all, examples of the disclosure there may be provided a physical entity embodying the computer program as described above.

According to various, but not necessarily all, examples of the disclosure there may be provided an electromagnetic carrier signal carrying the computer program as described above.

According to various, but not necessarily all, examples of the disclosure there may be provided an apparatus comprising: processing circuitry; and memory circuitry including computer program code; the memory circuitry and the computer program code configured to, with the processing circuitry, cause the apparatus at least to perform: creating gaze tracking information; determining whether a percentage of users who share gaze tracking information is above or below a threshold; and if the percentage of users who share gaze tracking information is above the threshold sharing the created gaze tracking information.

In some examples the apparatus may be configured such that if the percentage of users who share gaze tracking information is below the threshold the created gaze tracking information is not shared.

In some examples the apparatus may be configured such that determining whether a percentage of users who share gaze tracking information is above or below a threshold comprises receiving information from another apparatus relating to users who share gaze tracking information.

In some examples the information relating to users who share gaze tracking information may comprise at least one of: the percentage of users sharing gaze tracking information, the percentage of users sharing gaze tracking information relating to a given type of object, the percentage of users sharing gaze tracking information at a location.

In some examples there may be provided a portable electronic device comprising an apparatus as described above.

According to various, but not necessarily all, examples of the disclosure there may be provided a method comprising: creating gaze tracking information; determining whether a percentage of users who share gaze tracking information is above or below a threshold; and if the percentage of users who share gaze tracking information is above the threshold sharing the created gaze tracking information.

In some examples if the percentage of users who share gaze tracking information is below the threshold the created gaze tracking information is not shared.

In some examples determining whether a percentage of users who share gaze tracking information is above or below a threshold may comprise receiving information from another apparatus relating to users who share gaze tracking information.

In some examples the information relating to users who share gaze tracking information may comprise at least one of: the percentage of users sharing gaze tracking information, the percentage of users sharing gaze tracking information relating to a given type of object, the percentage of users sharing gaze tracking information at a location.

According to various, but not necessarily all, examples of the disclosure there may be provided a computer program comprising computer program instructions that, when executed by at least one processor, enable an apparatus at least to perform: creating gaze tracking information; determining whether a percentage of users who share gaze tracking information is above or below a threshold; and if a percentage of users who share gaze tracking information is above the threshold sharing the created gaze tracking information.

According to various, but not necessarily all, examples of the disclosure there may be provided a computer program comprising program instructions for causing a computer to perform the method described above.

According to various, but not necessarily all, examples of the disclosure there may be provided a physical entity embodying the computer program as described above.

According to various, but not necessarily all, examples of the disclosure there may be provided an electromagnetic carrier signal carrying the computer program as claimed described above.

According to various, but not necessarily all, examples of the disclosure there is provided examples as claimed in the appended claims.

### BRIEF DESCRIPTION

For a better understanding of various examples that are useful for understanding the detailed description, reference will now be made by way of example only to the accompanying drawings in which:

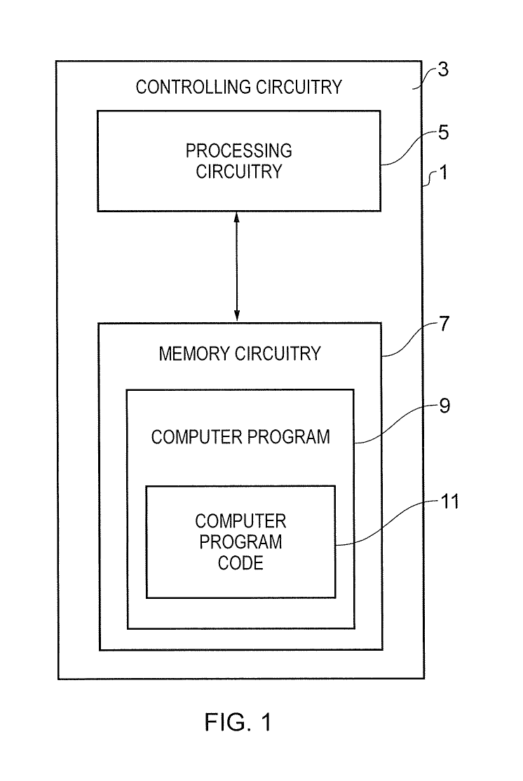

FIG. 1 illustrates an apparatus;

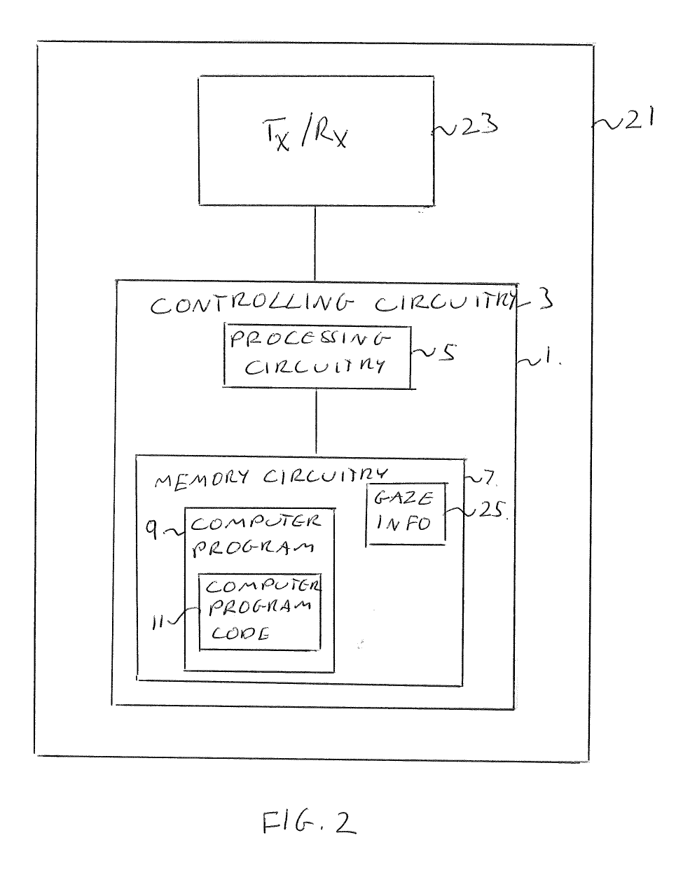

FIG. 2 illustrates a server comprising an apparatus;

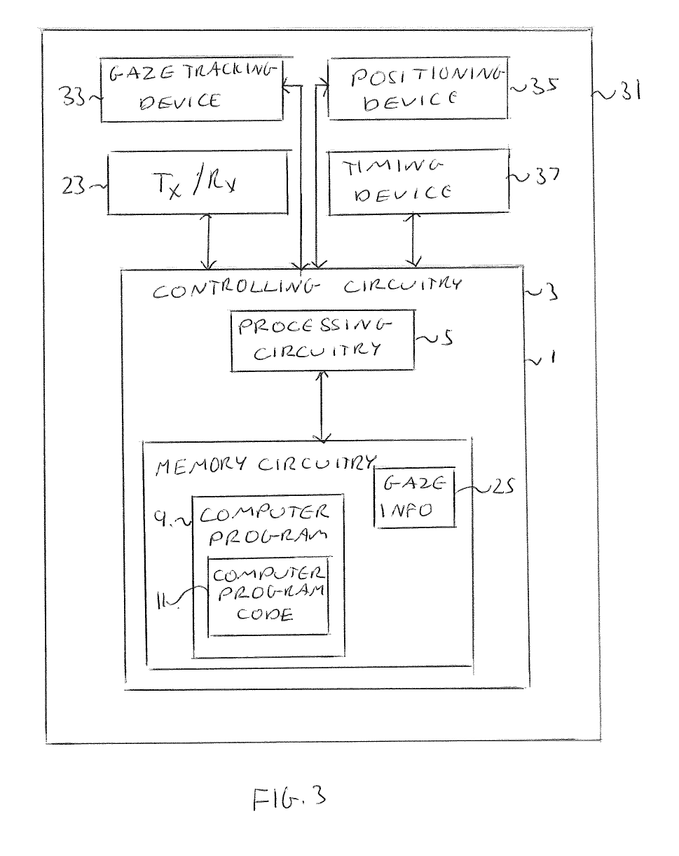

FIG. 3 illustrates a portable electronic device comprising an apparatus;

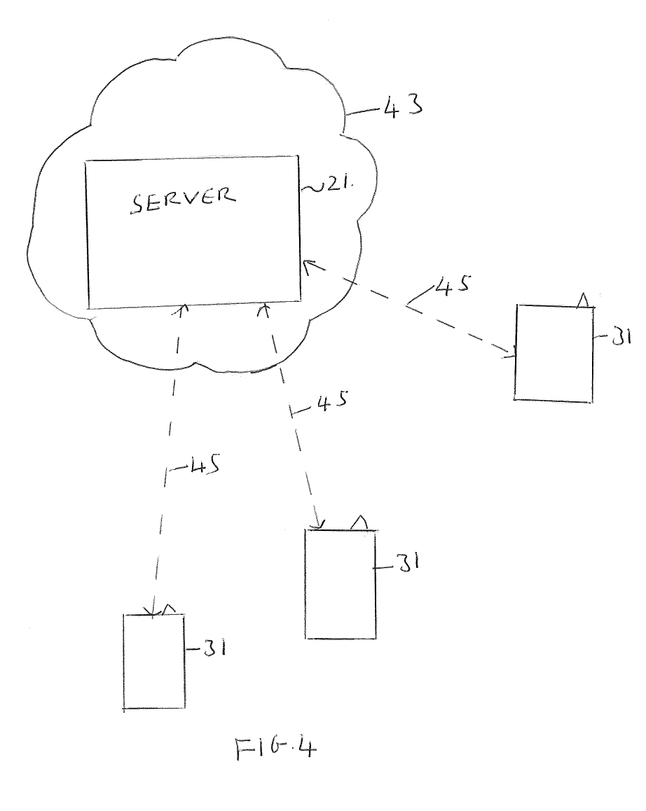

FIG. 4 illustrates a system comprising an apparatus;

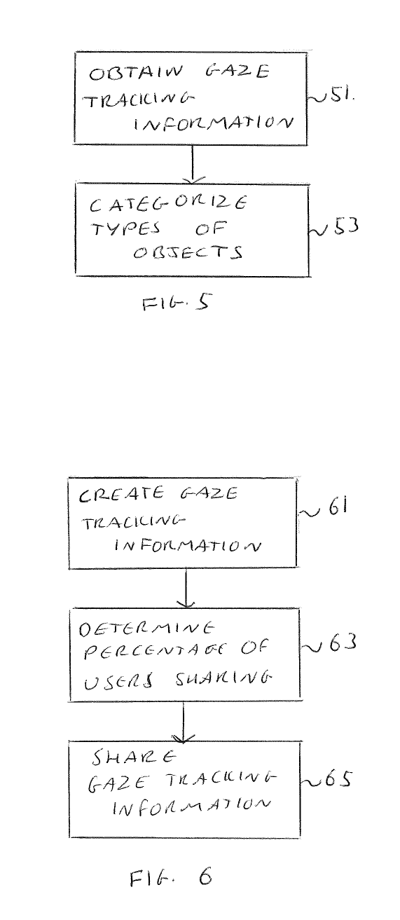

FIG. 5 illustrates a method;

FIG. 6 illustrates a method;

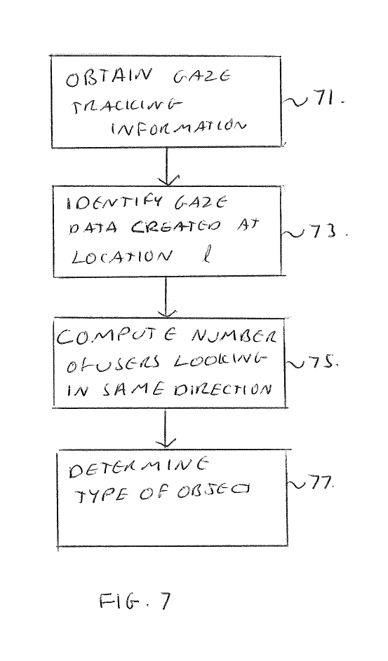

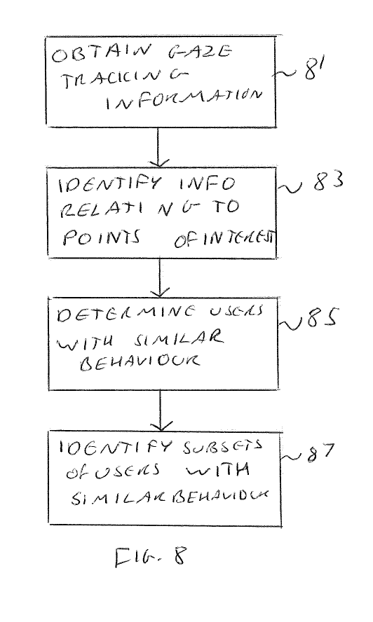

FIG. 7 illustrates a method of categorizing objects;

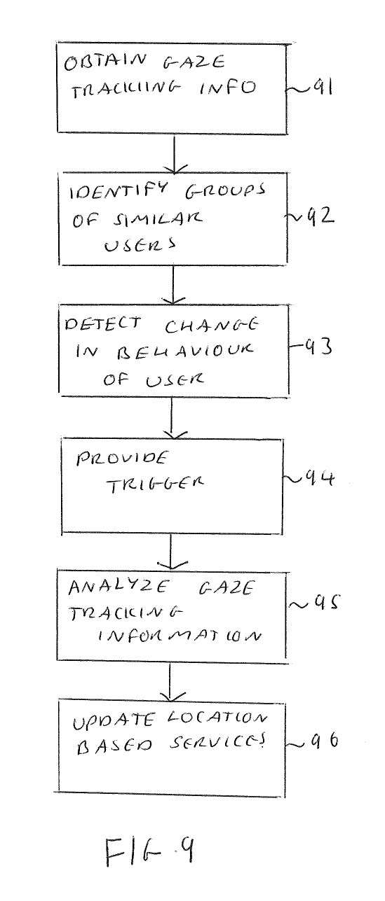

FIG. 8 illustrates a method of identifying groups of users with similar interests;

FIG. 9 illustrates a method of identifying changes in objects;

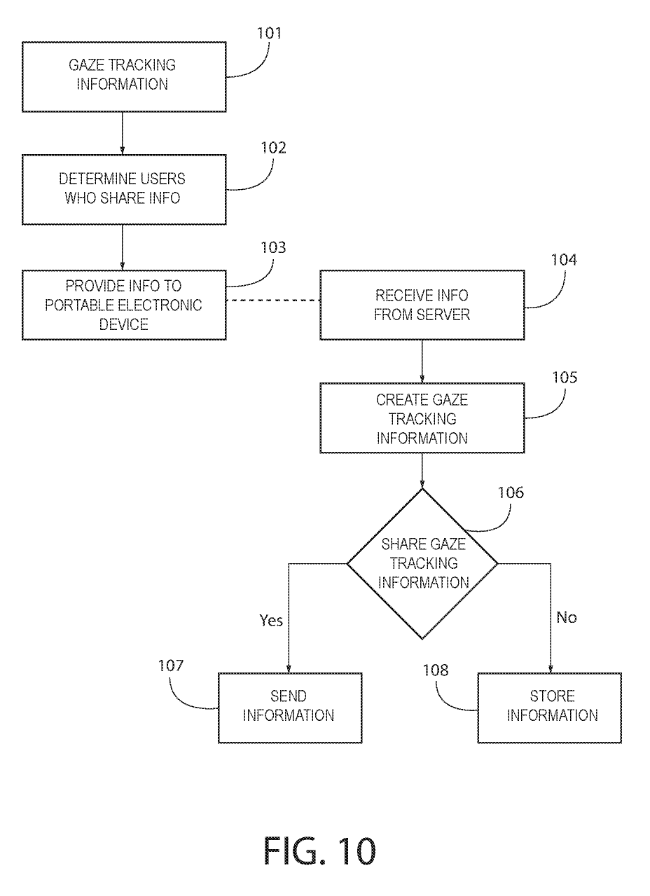

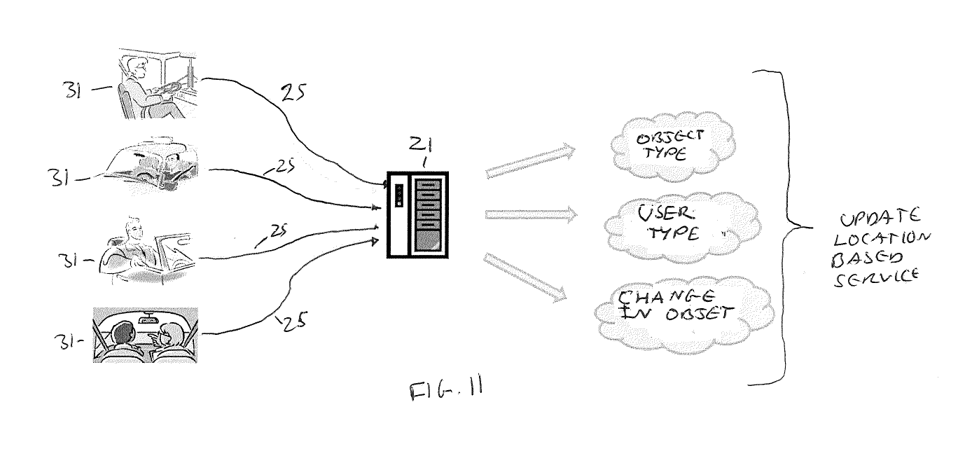

FIG. 10 illustrates a method of enabling sharing of gaze tracking information; and

FIG. 11 illustrates an example implementation of the disclosure.

### DETAILED DESCRIPTION

The Figures illustrate an apparatus 1 comprising: processing circuitry 5; and memory circuitry 7 including computer program code 11; the memory circuitry 7 and the computer program code 11 configured to, with the processing circuitry 5, cause the apparatus 1 at least to perform: obtaining 51 gaze tracking information 25 from a plurality of users wherein the gaze tracking information 25 indicates whether or not a user looked at an object; and analysing 53 the obtained gaze tracking information 25 to categorize objects as different types of objects.

The apparatus 1 may be for wireless communication. In some examples the apparatus 1 may be provided within a server 21 or any other suitable device.

The Figures also illustrate an apparatus 1 comprising: processing circuitry 5; and memory circuitry 7 including computer program code 11; the memory circuitry 7 and the computer program code 11 configured to, with the processing circuitry 5, cause the apparatus 1 at least to perform: creating 61 gaze tracking information 25; determining 63 whether a percentage of users who share gaze tracking information 25 is above or below a threshold; and if the percentage of users who share gaze tracking information 25 is above the threshold sharing 65 the created gaze tracking information 25.

The apparatus 1 may be for wireless communication. In some examples the apparatus 1 may be provided within a portable electronic device 31 or any other suitable device.

Examples of the disclosure provide apparatus 1, methods and computer programs 9 for obtaining gaze tracking information 25 from a plurality of users. The obtained gaze tracking information 25 may be used to ensure that up to date and/or appropriate services are provided to users. For example the information may be used to update maps or other location based services or to identify objects that may be of interest to particular users.

FIG. 1 schematically illustrates an example apparatus 1 which may be used in implementations of the disclosure. The apparatus 1 illustrated in FIG. 1 may be a chip or a chip-set. In some examples the apparatus 1 may be provided within a device such as a server 21. The server 21 may be configured for wireless communication with one or more portable electronic devices 31. In some examples the apparatus 1 may be provided within a portable electronic device 31 which may be configured to communicate with a server 21 and/or other devices.

The example apparatus 1 comprises controlling circuitry 3. In examples where the controlling circuitry 3 is provided within a server 21 the controlling circuitry 3 may provide means for obtaining 51 gaze tracking information 25 from a plurality of users wherein the gaze tracking information indicates whether or not a user looked at an object; and means for analysing 53 the obtained gaze tracking information 25 to categorize objects as different types of objects.

In examples where the controlling circuitry 3 is provided within a portable electronic device 31 the controlling circuitry 3 may provide means for creating 61 gaze tracking information 25; means for determining 63 whether a percentage of users who share gaze tracking information 25 is above or below a threshold; and means for sharing 65 the created gaze tracking information 25 if the percentage of users who share gaze tracking information 25 is above the threshold.

The processing circuitry 5 may be configured to read from and write to memory circuitry 7. The processing circuitry 5 may comprise one or more processors. The processing circuitry 5 may also comprise an output interface via which data and/or commands are output by the processing circuitry 5 and an input interface via which data and/or commands are input to the processing circuitry 5.

The memory circuitry 7 may be configured to store a computer program 9 comprising computer program instructions (computer program code 11) that controls the operation of the apparatus 1 when loaded into processing circuitry 5. The computer program instructions, of the computer program 9, provide the logic and routines that enable the apparatus 1 to perform the example methods illustrated in FIGS. 5 to 11. The processing circuitry 5 by reading the memory circuitry 7 is able to load and execute the computer program 9.

The apparatus 1 therefore comprises: processing circuitry 5; and memory circuitry 7 including computer program code 11, the memory circuitry 7 and the computer program code 11 configured to, with the processing circuitry 5, cause the apparatus 1 at least to perform: obtaining 51 gaze tracking information 25 from a plurality of users wherein the gaze tracking information 25 indicates whether or not a user looked at an object; and analysing 53 the obtained gaze tracking information 25 to categorize objects as different types of objects.

Alternative apparatus 1 may comprise: processing circuitry 5; and memory circuitry 7 including computer program code 11, the memory circuitry 7 and the computer program code 11 configured to, with the processing circuitry 5, cause the apparatus 1 at least to perform: creating 61 gaze tracking information 25; determining 63 whether a percentage of users who share gaze tracking information 25 is above or below a threshold; and if the percentage of users who share gaze tracking information 25 is above the threshold sharing 65 the created gaze tracking information 25.

The computer program 9 may arrive at the apparatus 1 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program. The delivery mechanism may be a signal configured to reliably transfer the computer program 9. The apparatus may propagate or transmit the computer program 9 as a computer data signal.

Although the memory circuitry 7 is illustrated as a single component in the figures it is to be appreciated that it may be implemented as one or more separate components some or all of which may be integrated/removable and/or may provide permanent/semi-permanent/dynamic/cached storage.

Although the processing circuitry 5 is illustrated as a single component in the figures it is to be appreciated that it may be implemented as one or more separate components some or all of which may be integrated/removable.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application-specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

FIG. 2 schematically illustrates a server 21. The server 21 may comprise an apparatus 1 and a transceiver 23. It is to be appreciated that only features necessary for the following description have been illustrated in FIG. 2.

The apparatus 1 comprised within the server of FIG. 2 may be as illustrated in FIG.

1 and described above. Corresponding reference numerals are used for corresponding features.

As described above the apparatus 1 comprises controlling circuitry 3. The controlling circuitry 3 comprises memory circuitry 7 and processing circuitry 5. The memory circuitry 7 may be configured to store a computer program 9 comprising computer program code 11. The memory circuitry 7 may also be configured to store obtained gaze tracking information 25. The obtained gaze tracking information 25 may be created by a plurality of remote user devices and received by the transceiver 23 of the server 21. The remote user devices may be portable electronic devices 31 or any other suitable devices.

The transceiver 23 may comprise one or more transmitters and/or receivers. The transceiver 23 may comprise any means which enables the server 21 to establish a communication connection with a remote apparatus and exchange information with the remote apparatus. The remote apparatus may be located in a portable electronic device 31. The communication connection may comprise a wireless connection.

In some examples the transceiver 23 may enable the server 21 to connect to a network such as a cellular network. In some examples the transceiver 23 may enable the apparatus 1 to communicate in local area networks such as wireless local area networks, Bluetooth networks or any other suitable network.

The transceiver 23 may be configured to provide information obtained via the transceiver 23 to the controlling circuitry 3. The transceiver 23 may also be configured to enable information from the controlling circuitry 3 to be transmitted via the transceiver 23.

FIG. 3 schematically illustrates a portable electronic device 31. The portable electronic device 31 may be a telephone, a navigation device, a wearable electronic device such as a near eye display or any other suitable electronic device 31. The portable electronic device 31 may be sized and shaped so that the user can hold the portable electronic device 31 in their hand or wear the portable electronic device 31 while they are using the or wearing the portable electronic device 31.

The portable electronic device 31 may comprise an apparatus 1, a transceiver 23, a gaze tracking device 33, a positioning device 35 and a timing device 37. It is to be appreciated that only features of the portable electronic device 31 necessary for the following description have been illustrated in FIG. 3. In some examples the portable electronic device 31 may comprise additional features such as a power supply and user interface or any other suitable features.

The apparatus 1 of FIG. 3 may be as illustrated in FIG. 1 and described above. Corresponding reference numerals are used for corresponding features.

As described above the apparatus 1 comprises controlling circuitry 3. The controlling circuitry 3 comprises memory circuitry 7 and processing circuitry 5. The memory circuitry 7 may be configured to store a computer program 9 comprising computer program code 11.

The transceiver 23 may comprise one or more transmitters and/or receivers. The transceiver 23 may comprise any means which enables the portable electronic device 31 to establish a communication connection with a remote apparatus and exchange information with the remote apparatus. The remote apparatus may be a server 21 and/or another portable electronic device 31. The communication connection may comprise a wireless connection.

In some examples the transceiver 23 may enable the portable electronic device 31 to connect to a network such as a cellular network. In some examples the transceiver 23 may enable portable electronic device 31 to communicate in local area networks such as wireless local area networks, Bluetooth networks or any other suitable network.

The transceiver 23 may be configured to provide information obtained via the transceiver 23 to the controlling circuitry 3. The transceiver 23 may also be configured to enable information from the controlling circuitry 3 to be transmitted via the transceiver 23.

The gaze tracking device 33 may comprise any means which may be configured to monitor the gaze of the user and provide gaze tracking information 25. The information created by the gaze tracking device 33 may be used to determine which objects a user is looking at.

In some examples the gaze tracking device 33 may comprise a wearable device such as a near eye display. The near eye display may comprise, a camera or an image recognition device or other means for determining the position of a users pupils. The positions of the user's pupils may be used to identify the direction that the user is looking in.

In other examples the gaze tracking device 33 may comprise a device such as a camera which may be positioned in front of the user. For instance the camera may be positioned on the dashboard of a vehicle to track the gaze of the user. The camera may be configured to determine the position of the pupils of the user and the position of the user's head to identify the direction that the user is looking in.

In the example of FIG. 3 the gaze tracking device 33 is illustrated as part of the portable electronic device 31. It is to be appreciated that in other examples the gaze tracking device 33 may be provided separate to the portable electronic device 31. In such examples the gaze tracking device 33 may be configured to transmit the gaze tracking information to the portable electronic device 31. The gaze tracking device 33 may be configured to transmit the gaze tracking information to the portable electronic device 31 using a short range wireless communication link such as Bluetooth or near field communication (NFC) or any other suitable means.

The positioning device 35 may comprise any means which may be configured to enable the position of the portable electronic device 31 to be determined. The positioning device 35 may comprise GNSS (global navigation satellite systems) sensors such as GPS (Global positioning system) sensors, GLONASS (Globalnaya navigatsionnaya sputnikovaya sistema) sensors or any other suitable types of sensors. The positioning device 35 may be configured to determine the location at which gaze tracking information 25 is obtained.

The example portable electronic device 31 of FIG. 3 also comprises a timing device 37. The timing device 37 may comprise any means which may be configured to determine the time at which gaze tracking information 25 is obtained. The timing device 37 may comprise a clock or other suitable means. In some examples the portable electronic device 31 may obtain the timing information from a received input signal.

FIG. 4 illustrates a system 41 comprising a server 21 and one or more portable electronic devices 31. The server 21 may be as described above in relation to FIG. 2. The one or more portable electronic devices 31 may be as described above in relation to FIG. 3. The one or more portable electronic devices 31 may be dispersed over a large area such as a city or a part of a country.

The server 21 may be located remotely from the one or more portable electronic devices 31. The server 21 may be located within a communications network 43 which may be accessed by the one or more portable electronic devices 31.

The server 21 and portable electronic devices 31 may be configured to enable communication links 45 to be established between the server 21 and the portable electronic devices 31. The communication links 45 may comprise wireless communication links 45. The wireless communication links 45 may be part of a communications network 43 such as a cellular communications network 43 or a local area network.

The communication links 45 may comprise any means which may enable information to be exchanged between the server 21 and the one or more portable electronic devices 31. This may enable the server 21 to obtain information from the portable electronic devices 31. The information which is provided obtained by the server 21 from the portable electronic devices 31 may comprise information which is collected by the gaze tracking device 33. The information may comprise information indicating the location of the portable electronic devices 31 when the gaze tracking information 25 was obtained and/or information relating to the time when the gaze tracking information 25 was obtained.

The communication links 45 may also enable the server 21 to provide information to the portable electronic devices 31. The information which is provided from the server 21 to the portable electronic devices 31 may include information relating to the obtained gaze tracking information 25 or the users who have shared their gaze tracking information 25.

In the example system of FIG. 4 three portable electronic devices 31 are shown. It is to be appreciated that any number of portable electronic devices 31 may be provided in other examples of the disclosure. In the example system of FIG. 4 the server 21 is provided as a single apparatus 1. In some examples a plurality of servers 21 may be provided.

FIGS. 5 to 11 are block diagrams which schematically illustrate example methods. The methods of FIGS. 5 to 11 may be implemented using the example apparatus 1, server 21, portable electronic devices 31 and system 41 of FIGS. 1 to 4 and as described above.

The method of FIG. 5 may be implemented by a server 21 such as the example server 21 of FIG. 2. The server 21 may be configured to communicate with one or more portable electronic devices 31.

At block 51 the method comprises obtaining gaze tracking information 25 from a plurality of users. The gaze tracking information 25 may indicate whether or not a user looked at an object. At block 53 the method may comprise analysing 53 the obtained gaze tracking information 25 to categorize objects as different types of objects.

The method of FIG. 6 may be implemented by a portable electronic device 31 such as the portable electronic device 31 of FIG. 3. The portable electronic device 31 may be configured to communicate with a remote server 21.

The example method of FIG. 6 comprises, at block 61, creating gaze tracking information 25 and determining, at block 63, whether a percentage of users who share gaze tracking information 25 is above or below a threshold. If the percentage of users who share gaze tracking information 25 is above the threshold then, at block 65, the created gaze tracking information 25 is shared.

FIG. 7 shows an example method which may be used to categorize objects as different types of objects. The method of FIG. 7 may be implemented by a server 21 such as the example server 21 of FIG. 2. The server 21 may be configured to communicate with one or more portable electronic devices 31.

The method of FIG. 7 comprises analysing gaze tracking information 25 which is obtained from a plurality of users to quantify differences in gaze behaviour of different users. The difference in the gaze behaviour may comprise differences in the directions that the users look in at specific locations. This may then be used to categorize objects as different types of objects.

The different types of objects may comprise objects which may be located along a route which a user may be travelling. The different types of objects may comprise objects providing information for road users and points of interest and any other suitable types of objects.

The objects which provide information for road users may comprise important and/or essential objects. The objects may be important and/or essential in that all or almost all road users may need to look at them. For example the important or essential objects may comprise objects such as traffic lights, road signs, hazards or potential hazards or any other suitable objects.

The points of interest may comprise objects that may be looked at be some users, but need not be looked at by all users. For instance a point of interest could be a location along a route such as a shop or business or house or any other suitable type of object. An object may be determined to be of interest if the proportion of users that view the object is above a threshold.

The example method of FIG. 7 comprises, at block 71, obtaining gaze tracking information 25 from a plurality of users. The gaze tracking information 25 may comprise at least one of identification of a user, identification of time when the gaze tracking information 25 was collected, the location at which the gaze tracking information 25 was collected, the direction of the user's gaze, information 25 relating to an object that the user was looking at.

The gaze tracking information 25 may be created by a gaze tracking device 33 of a portable electronic device 31 and then transmitted to the server 21. The server 21 may obtain gaze tracking information 25 from a plurality of portable electronic devices 31.

In the example of FIG. 7 the gaze tracking information 25 is given by G and comprises n data items and is represented as follows:
G=(u₁, t₁, l₁, d₁, o₁), (u₂, t₂, l₂, d₂, o₂) . . . , (uₙ, tₙ, lₙ, dₙ, oₙ)
   where

uᵢ: refers to the identity of the user whose gaze data was monitored.

tᵢ: refers to the timestamp when the gaze data item was monitored.

lᵢ: refers to the corresponding gaze location.

dᵢ: refers to user uᵢ's gaze direction at time tᵢ and location lᵢ.

oᵢ: refers to the object at which the user was gazing.

In an example system 41 such as the system of FIG. 4 each of the plurality of portable electronic devices 31 may be associated with a different user and may be configured to provide data items uᵢ indicative of the identity of the user associated with the portable electronic device 31.

The timing devices 37 of the respective portable electronic devices 31 may be configured to provide the data items tᵢ to provide an indication of the time when the gaze data was collected by the portable electronic devices 31. In some examples the gaze tracking information 25 may be transmitted to the server 21 as soon as it is obtained. In other examples the gaze tracking information may be stored in the electronic device 31 and may be uploaded to the server 21 at a later point in time.

The positioning devices 35 of the respective portable electronic devices 31 may be configured to provide the data items lᵢ to provide an indication of the location of the user when the gaze data was created by the portable electronic devices 31.

The gaze tracking devices 33 of the respective portable electronic devices 31 may be configured to provide the data items dᵢ to provide an indication of the direction of the gaze of the user at the time and location when the gaze data was collected by the portable electronic devices 31.

The gaze tracking devices 33 of the respective portable electronic devices 31 may be configured to provide the data items oᵢ to provide an indication of the object that the user is looking at. The object oᵢ that the user is looking at may be identified from the location of the user and the direction that they are looking in.

At block 73 the method comprises identifying the gaze data which was created at a given location l. In some examples block 73 may comprise retrieving the subset of data items G′ from the obtained gaze tracking information 25 where subset of data items G′ comprises the gaze tracking information which was obtained at a given location l.
G′:={(uᵢ, tᵢ, dᵢ, oᵢ)∈ G [symbol] lᵢ=l}

At block 75 the method comprises computing the number of users who look in the same direction and/or at the same object at the given location l. The method may comprise using G′ to compute the number P of users gazing in the same direction at the given location l.

In some examples the computation may proceed as follows:
a) Let D denote the set of (all) different directions in which the users in G′ were looking.
   That is, for D initialized to Φ (empty set),
   D:=D υ dᵢ, ∀(uᵢ, tᵢ, lᵢ, dᵢ, oᵢ)∈ G′
b) For each direction dₖ in D, compute the cardinality of the subset Pₖ of unique users who were gazing in direction dₖ.
   Pₖ:=|{(uᵢ, tᵢ, lᵢ, dᵢ, oᵢ)∈ G′ [symbol] dᵢ=dₖ}|
c) P:=max (P₁, P₂ . . . , Pₘ) where m=|D|.

At block 77 the object type is determined. For instance it may be determined if the object provides information for road users or is a point of interest or is any other type of object.

In some examples the object type may be determined by defining gaze percentage thresholds for different object types. The object can then be identified by determining the percentage of users that look at the object. For instance objects which provide information for road users may be essential or very important for drivers or other road users to look at. This means that all or almost all users will look at these objects. Objects which are looked at by only a limited subset of users may be classified as objects of interest if the number of users within the subset of users is above a given threshold.

In some examples the calculation may be performed as follows:

Let M denote the map of object types Tᵢ with respect to their corresponding gaze percentage threshold ranges (P_{TiMin}, P_{TiMax}).

$$M = \{ {T}_{1} \text{:} ( {P}_{T 1 Min} , {P}_{T 1 Max} ) , {T}_{2} \text{:} ( {P}_{T 2 Min} , {P}_{T 2 Max} ) … \}$$

$$Let P \text{:} = max ( {P}_{1} , {P}_{2} … , {P}_{k} , … , {P}_{m} ) = {P}_{k} \\ If {P}_{TiMin} \leq \frac{\vert {P}_{k} \vert}{\vert G \vert} \times 100 \leq {P}_{TiMax}$$

then the object oₖ which users gazed up on at location l is of type Tᵢ.

Once objects have been identified as certain types of objects this may enable improved services to be provided to users. For instance maps or other location services may be updated with information about the types of objects. Also the information about the types of objects may be used to identify groups of similar users and changes in the objects.

FIG. 8 shows an example method which may be used to identify groups of users with similar interests. The method of FIG. 8 may be implemented by a server 21 such as the example server 21 of FIG. 2. The server 21 may be configured to communicate with one or more portable electronic devices 31.

In the example method of FIG. 8 the gaze tracking information 25 which is obtained from a plurality of users is used to identify groups of users with similar interests. In the example of FIG. 8 the groups of users with similar interests are identified by comparing the gaze tracking information 25 obtained from different users to identify users who look at similar types of objects at different locations.

At block 81 the method comprises obtaining gaze tracking information 25 from a plurality of users. In the example of FIG. 8 the gaze tracking information 25 is given by G and comprises n data items and is represented as follows:
G=(u₁, t₁, l₁, d₁, o₁), (u₂, t₂, l₂, d₂, o₂) . . . , (uₙ, tₙ, lₙ, dₙ, oₙ)

Where the data items uₙ, tₙ, lₙ, dₙ, oₙ represent the identity of the user, the timestamp, the location, the gaze direction and the object as described above with respect to FIG. 7.

At block 83 the method comprises identifying the gaze data which relates to users looking at points of interest. The points of interest may be objects which are not essential so that only some of the users look at them.

In some examples block 83 may comprise filtering the obtained gaze tracking information 25 to determine the subset G′ of gaze observations where the users were looking at objects other than objects which all or almost all users look at. The filtering removes gaze tracking information 25 where the users were looking at objects determined to be essential for a driver or other objects which provide information to road users such as traffic lights.

The example method of FIG. 7 may be used to classify the types of objects. In the example of FIG. 8 TD denotes the object type corresponding to objects which provide information to a road user. The method of FIG. 8 may therefore comprise filtering out gaze observations, where the users were looking at objects of type TD.
G′:={(uᵢ, tᵢ, lᵢ, dᵢ, oᵢ)∈ G [symbol] type(oᵢ)≠T_{D}}
   Filtering out gaze tracking information 25 relating to objects which all or almost all users look at enables users to be categorized according to common interests and behaviors. The information relating to objects which all or almost all users look at does not enable different groups of users to be distinguished because the behavior pattern is not unique to a particular group of users.

At block 85 the method comprises determining users with similar gaze behavior. In some examples block 85 may comprise identifying users who look at the same objects at the same locations. In some examples this may comprise determining the sets of users U_{(d, l)} who look in a given direction d at a location l. This may be preformed for each unique pair (d, l) in G′.
U_{(d, l)}:={(uᵢ, lᵢ, dᵢ, oᵢ)∈ G′ [symbol] dᵢ=d AND lᵢ=l}

This gives an output of a plurality of different sets of users where users within the set have been identified as having similar gaze behaviour patterns:
U_{(d, l)1}, U_{(d, l)2}, . . .

At block 87 the method comprises grouping users with similar gaze behaviour patterns into subsets. In some examples subsets of users with similar gaze behaviour patterns may be identified by computing the subsets of users who are members of the same set U_{(d, l)i} in more than a threshold number t of sets. That is the users who have been identified as looking at the same object in more than a threshold number of locations are grouped into a subset. In some examples each of the subsets may comprise more than two users.

This enables a group of users Uₛ=(u₁, u₂, u₃) to be categorized as similar users in terms of their gaze behaviour if the number of sets U_{(d, l)i} such that
(u₁ ∈ U_{(d, l)i}) AND (u₂ ∈ U_{(d, l)i}) AND (u₃ ∈ U_{(d, l)i})

is greater than or equal to the threshold t.

Once a user has been identified as belonging to a group of users this may enable improved services to be provided to the users. For instance it may enable services which are provided to be tailored to the group of users. In some examples the behaviour of the group of users may be monitored to provide more accurate and up to date information than can be obtained with a single user. In some examples the information about the groups of users that a user can belong to may be used to determine changes in objects or to enable a user to set privacy settings according to the behaviour of other similar users.

FIG. 9 shows an example method which may be used to determine changes in objects. In some examples the method of FIG. 9 may be implemented by a server 21 such as the example server 21 of FIG. 2. The server 21 may be configured to communicate with one or more portable electronic devices 31.

Changes in objects may be determined by comparing gaze tracking information 25 created at a first time with gaze tracking information created at a second time. The gaze tracking information 25 may be created at the same location.

In the example method of FIG. 9 changes in objects are identified by comparing gaze tracking information 25 obtained from groups of similar users. The method of FIG. 8, or any other suitable method, may be used to identify similar users.

The example method of FIG. 9 comprises, at block 91, obtaining gaze tracking information 25 from a plurality of users. The gaze tracking information 25 is given by G and comprises n data items and may be represented as follows:
G=(u₁, t₁, l₁, d₁, o₁), (u₂, t₂, l₂, d₂, o₂) . . . , (uₙ, tₙ, lₙ, dₙ, oₙ)

Where the data items uₙ, tₙ, lₙ, dₙ, oₙ represent the identity of the user, the timestamp, the location, the gaze direction and the object as described above with respect to FIGS. 7 and 8.

At block 92 groups of similar users U_{S1}, U_{S2}, . . . may be identified. The groups of users may be identified using the example methods described above. The groups of users may be identified based on gaze tracking information 25 which was created during a given time period. For instance, the groups of users may be identified based on gaze tracking information 25 which was created up to a given time tⱼ.

At block 93 the method comprises detecting a change in the behaviour of a user at a given location. A change in behaviour may comprise a user looking in a different direction at a given location compared to the directions that they have looked in at previous points in time.

For example, for a user uᵢ, and two gaze observations (uᵢ, tⱼ, lₓ, dₓ, oₓ) and (uᵢ, tⱼ₊₁, l_{y}, d_{y}, o_{y}); it will be determined that there has been a change in the behaviour if
(lₓ=l_{y}) AND (dₓ≠d_{y})

At block 94, after a change in behavior has been detected a trigger may be provided. In some examples the trigger may be provided if a single change in behavior is detected by a single user. In some examples the number of events which represent a change in behavior may have to exceed a given threshold. For instance a threshold number of users may have to change the direction they look in at the same location before the trigger is provided.

The trigger may cause the processing circuitry 5 to analyze the gaze tracking information 25 of other users at the same location at block 95. The other users may be determined to be similar users. The gaze tracking information 25 may be created after the given time tⱼ.

For instance, the gaze tracking information 25 which is analyzed may comprise gaze tracking information 25 created by similar users at location l around time tⱼ₊₁. In the following explanation the time around time tⱼ₊₁ is denoted as ˜tⱼ₊₁.

The group of users similar to the user uᵢ is given by
uᵢ ∈ U_{Sk}=(u₁, u₂, . . . , uᵢ, . . . ).

Analyzing the gaze tracking information of other users may comprise checking if a change is also detected in the gaze behavior of users uk (other than uᵢ) in the group of users Usk from times before tⱼ and ˜tⱼ₊₁. A change in behaviour may be identified if a threshold number of users in the group are determined to be looking in a different direction at the given location.

For example, a change will be determined if, all users in the group, other than the initial user, are looking at a different direction at the given location l. That is if ∀ uₖ(≠uᵢ)∈ U_{Sk}, and the gaze tracking information created at location l: (uₖ, <tⱼ, l, dₓ, oₓ) and (uₖ, ˜tⱼ₊₁, l, d_{y}, o_{y}); if
(lₓ=l_{y}) AND (dₓ≠d_{y})
   then the change noticed by the initial user uᵢ is validated.
   Once a change has been validated, at block 96 information relating to the object may be updated in a map or other location based service. For instance object oₓ may be replaced with new object o_{y} at location l in a map.

The example method of FIG. 9 enables interactive location based services to be provided. Data which is created by a plurality of users can be used to ensure that location based services are kept up to date. As the data is obtained from a plurality of users this ensures that the information which is used to update the location based service is accurate and reliable. Also gaze tracking information 25 which is used to update the location based service can be obtained automatically by monitoring the direction that the user is looking in. This does not require any specific input by the user and so it is easy and convenient for the user to provide the date which is collected from them.

As an illustrative example, the method of FIG. 9 may be used to detect temporary roadworks. All or almost all of the road users may look at the temporary roadworks. The method of FIG. 9 enables the new object to be determined and identified as roadworks or other object important or essential for road users. This information may be used to update a map to inform other road users about the location of the roadworks. This information may be taken into account, for example, in route planning or navigation services.

At a later point in time the method of FIG. 9 may be used again to determine that the roadworks have been completed. Once the temporary roadworks have been removed all or almost all of the road users will no longer look at the point where the roadworks were located. This information can be used to infer that the road works have been completed and the maps and other location based services can be updated accordingly.

In the above described example it is described that the server 21 may implement the method of FIG. 9, it is to be appreciated that in other examples other devices may be used to implement the method. In some examples some of the blocks of the method may be performed by the portable user devices 31. For instance a user's portable electronic device 31 may detect a change in the behaviour of a user at a given location and may then provide a trigger to server 21 that a change has been identified for that particular user. The server 21 may then compare the behaviour of the trigger user with behaviours of other users.

FIG. 10 shows an example method which may be used to control which information is shared by a portable user device 31. The method of FIG. 10 may be implemented by a system 41 such as the example system 41 of FIG. 4. The system 41 may comprise a server 21 which may be configured to communicate with one or more portable electronic devices 31.

The example method of FIG. 10 may enable a user to control which gaze tracking information 25 they share based on the behaviour of other users.

In the example of FIG. 10 blocks 101 to 103 are performed by a server 21 and blocks 104 to 108 are performed by a portable electronic device 31. In other examples the blocks of the method may be performed by different entities or in a different order.

At block 101 the server 21 obtains gaze tracking information 25 from a plurality of portable electronic devices 31. The gaze tracking information 25 may be as described above.

At block 102 the percentage of users who share the gaze tracking information 25 may be determined. Some users may control the portable electronic devices 31 to prevent sharing some or all of the gaze tracking information 25 which is created by their portable electronic devices 31.

In some examples the users may selectively control the portable electronic devices so that they share some gaze tracking information 25 but do not share other gaze tracking information 25. For instance a user may decide to share gaze tracking information 25 which relates to a first type of object but not other types of objects. As an example a user may decide to share information about which objects that provide information to road users they look at but may wish not to share information about which points of interest they look at. The example methods described above may be used to determine the types of objects.

In other examples some users may decide to share information at some locations but not at others.

In some examples, at block 102 the server 21 may comprise identify information relating to users who share gaze tracking information 25. The information relating to users who share gaze tracking information 25 may comprise the percentage of all users who share gaze tracking information 25. In other examples the server 21 may identify the percentage of different types of users who share particular types of gaze tracking information 25 or any other suitable information. The methods described above may be used to identify the different types of users.

In some examples information relating to users who share gaze tracking information 25 may comprise the percentage of users sharing gaze tracking information 25 relating to a given type of object, the percentage of users sharing gaze tracking information 25 at a location or any other suitable information.

At block 103 the information relating to the percentage of users who share their information is provided to a portable electronic device 31. For instance, the information may be transmitted via the transceiver 23 of the server 21 to a portable electronic device 31. In some examples the information may be provided to the portable electronic device periodically, for example at regular intervals. In other examples the information may be provided in response to a request from the portable electronic device 31.

At block 104 the information relating to the percentage of users who share their information is received by the portable electronic device 31. The information may be stored in the memory circuitry 7 of the portable electronic device 31.

At block 105 gaze tracking information 25 is created and at block 106 it is determined whether or not the created gaze tracking information should be shared. If it is determined, at block 106, that the gaze tracking information 25 should be shared then at block 107 the gaze tracking information 25 is transmitted to the server 21.

If it is determined, at block 106, that the gaze tracking information should not be shared then the method proceeds to block 108 and the gaze tracking information 25 is not transmitted to the server 21. If the gaze tracking information 25 is not shared, then the created gaze tracking information 25 may be stored in the memory circuitry 5 of the portable electronic device 31. This may enable the created gaze tracking information 25 to be used personally by the user even if they do not wish to share it.

In some examples a user may define privacy policies which may determine whether or not they wish to share the created gaze tracking information 25. For instance, in some examples a user may decide that they do not wish to share gaze tracking information 25 created at a given location l. In such examples the location l may be classified as sensitive or private in the user's privacy policy. In such examples determining whether or not created gaze tracking information 25 should be shared may comprise, for a gaze observation (uᵢ, tᵢ, lᵢ, dᵢ, oᵢ), checking if the location lᵢ is classified as a sensitive location by the user's privacy policies. If lᵢ is classified as a sensitive location then the gaze observation (uᵢ, tᵢ, lᵢ, dᵢ, oᵢ) is not shared with the server 21.

In other examples a user may decide that they do not wish to share gaze tracking information 25 relating to a given type of object oᵢ. In such examples the object oᵢ may be classified as sensitive or private in the user's privacy policy. In such examples determining whether or not created gaze tracking information 25 should be shared may comprise, for a gaze observation (uᵢ, tᵢ, lᵢ, dᵢ, oᵢ), checking if the object oᵢ is classified as a sensitive object by the user's privacy policies. If oᵢ is classified as a sensitive location then the gaze observation (uᵢ, tᵢ, lᵢ, dᵢ, oᵢ) is not shared with the server 21.

In other examples a user may decide to share information based on the behaviour of other users. In such examples determining whether or not created gaze tracking information 25 should be shared may comprise using the information which has been obtained from the server 21 indicating the percentage of users who share information. If the percentage of users who share gaze tracking information 25 is above the threshold then the created gaze tracking information 25 would be shared at block 107. If the percentage of users who share gaze tracking information 25 is below the threshold then the created gaze tracking information 25 is not shared. In some examples the user may be able to set the threshold percentage of sharing users as part of their privacy policy.

In some examples if it is determined, at block 106, that the gaze tracking information 25 is private then none of the gaze tracking information 25 might be shared. In other examples if it is determined, at block 106, that the gaze tracking information 25 is private then some of gaze tracking information 25 may be shared but some data items may be hidden. For instance only the data items (uᵢ, tᵢ, _, dᵢ, oᵢ) might be shared if the gaze tracking information is created at a sensitive location lᵢ. Similarly only the data items (uᵢ, tᵢ, lᵢ, _, _) might be shared if the gaze tracking information 25 relates to a sensitive object or type of object oᵢ.

In other examples the data which is shared may be modified to protect the privacy of the user. For example the where the created gaze tracking information obtained is (uᵢ, tᵢ, lᵢ, dᵢ) the information that is actually shared may be (uᵢ, t′ᵢ, lᵢ, dᵢ) where t′ᵢ is a modified time stamp which is different from the actual timestamp t1. Modifying the time stamp of the user may enable the activity of the user to be kept private while allowing some information to be shared. It is to be appreciated that other data items may be modified in other examples of the disclosure.

The example method of FIG. 10 enables a user to set privacy restrictions on the data which is shared. The privacy restrictions may be set based on the behavior of other users which means that the restrictions may change automatically, based on the behavior of other users, without the need for any specific input from the user.

As an illustrative example a user driving along a route may observe a set of traffic lights. Gaze tracking information 25 may be created recording that the user has looked at the traffic lights.

The traffic light may be determined to be an object which provides information which is important or essential for road users. The methods described above may be used to identify the type of object. The user may have set their privacy settings so that they only share gaze tracking information 25 relating to objects which provide information which is important or essential for road users. The portable electronic device 31 may use the methods of FIG. 10 to check whether or not the created gaze tracking information 25 should be shared. In this example, the user has indicated that they would like to share information relating to this type of object so the gaze tracking information 25 can be shared with the server 21 and used to ensure that the maps and other location based services are kept up to date.

As another illustrative example the same user driving along another route may observe a point of interest such as a business or other building. In this example the point of interest may comprise a bookshop. Gaze tracking information may be created recording that the user has looked at the bookshop. The bookshop may be determined not to be an object which provides information which is important or essential for road users. The portable electronic device 31 would then determine that, for this user, the information should not be shared.

Data about which information is shared and which information is not shared may be provided to the server 21 and used to ensure that the crowd based privacy policies are kept up to date.

FIG. 11 illustrates an example implementation of the disclosure which shows how the gaze tracking information 25 which is obtained from a plurality of portable electronic devices 31 may be used to provide updates services.

In the example of FIG. 11 a plurality of portable electronic devices 31 associated with a plurality of users create gaze tracking information 25. In the example of FIG. 11 each of the users are driving. In other examples the users need not be driving, for instance the users may be pedestrians, or using other modes of transport or may be passengers within a vehicle.

The gaze tracking information 25 is sent to the server 21. The gaze tracking information 25 may be sent to the server 21 in accordance with privacy settings which may be set by the user of the portable electronic device 31.

The server 21 can then use the obtained gaze tracking information 25 to categorize objects according to types of objects, to categorize users as types of users according to their gaze behaviour patterns and to determine changes in objects. This information may then be used to update location based service such as maps or other services.

Examples of the disclosure provide for a system in which gaze tracking information 25 may be used to provide reliable and up to date map service and other location based services. The gaze tracking information 25 may be created and provided to the server 21 without the need for any specific input from the user. This makes it easy for the information to be collected and may increase the reliability of the information collected by the server. The examples of the disclosure also provide privacy policies which ensure that the user can easily prevent information that they do not wish to share from being shared.

The blocks illustrated in the FIGS. 5 to 10 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

We claim:

1. An apparatus comprising:
processing circuitry; and
memory circuitry including computer program code;
the memory circuitry and the computer program code configured to, with the processing circuitry, cause the apparatus at least to perform:
obtaining gaze tracking information from a plurality of users wherein the gaze tracking information indicates whether or not a user looked at an object; and
analysing the obtained gaze tracking information to categorize objects as different types of objects.

2. An apparatus of claim 1 wherein the information that is used to categorise objects comprises the percentage of users in a given location with gaze tracking information indicating that they were looking at a given object.

3. An apparatus of claim 1 wherein the different types of objects comprise objects providing information for road users and points of interest.

4. An apparatus of claim 1 further comprising comparing gaze tracking information from different users to identify groups of users with similar interests.

5. An apparatus of claim 4 wherein groups of users with similar interests are identified by analysing the obtained gaze tracking information to identify users who look at similar types of objects at different locations.

6. An apparatus of claim 1 further comprising analysing the obtained gaze tracking information to determine changes in objects.

7. An apparatus of claim 6 wherein changes in objects are determined by comparing gaze tracking information obtained at a first time with gaze tracking information obtained at a second time.

8. An apparatus of claim 6 wherein changes in objects are determined by comparing gaze tracking information from a plurality of users having similar interests.

9. An apparatus of claim 6 further comprising using information indicative of a change in an object to provide information to other users.

10. An apparatus of claim 1 further comprising identifying information relating to users who share gaze tracking information.

11. An apparatus of claims 10 wherein the information relating to users who share gaze tracking information comprises at least one of: the percentage of users sharing gaze tracking information, the percentage of users sharing gaze tracking information relating to a given type of object, the percentage of users sharing gaze tracking information at a location.

12. An apparatus of claim 10 further comprising providing information relating to users who share gaze tracking information to the user devices.

13. An apparatus of claim 1 wherein the gaze tracking information comprises at least one of identification of a user, identification of time when the gaze tracking information was collected, the location at which the gaze tracking information was collected, the direction of the user's gaze, information relating to an object that the user was looking at.

14. A method comprising:
obtaining gaze tracking information from a plurality of users wherein the gaze tracking information indicates whether or not a user looked at an object; and
analysing the obtained gaze tracking information to categorize objects as different types of objects.

15. A method of claim 14 wherein the information that is used to categorise objects comprises the percentage of users in a given location with gaze tracking information indicating that they were looking at a given object.

16. A method of claim 14 wherein the different types of objects comprise objects providing information for road users and points of interest.

17. A method of claim 14 further comprising comparing gaze tracking information from different users to identify groups of users with similar interests.

18. A method of claim 17 wherein groups of users with similar interests are identified by analysing the obtained gaze tracking information to identify users who look at similar types of objects at different locations.

19. An apparatus comprising:
processing circuitry; and
memory circuitry including computer program code;
the memory circuitry and the computer program code configured to, with the processing circuitry, cause the apparatus at least to perform:
creating gaze tracking information;
determining whether a percentage of users who share gaze tracking information is above or below a threshold; and
if the percentage of users who share gaze tracking information is above the threshold sharing the created gaze tracking information.

20. An apparatus of claim 19 wherein if the percentage of users who share gaze tracking information is below the threshold the created gaze tracking information is not shared.
